(19) United States
(12) Patent Application Publication
(10) Pub. No.: US 2014/0203983 A1
(43) Pub. Date: Jul. 24, 2014

(54) APPARATUS AND METHOD FOR CONTROLLING ANTENNA IN MOBILE COMMUNICATION SYSTEM

(71) Applicant: Samsung Electronics Co., Ltd., Suwon-si (KR)

(72) Inventor: Chan LEE, Yongin-si (KR)

(73) Assignee: Samsung Electronics Co., Ltd., Suwon-si (KR)

(21) Appl. No.: 14/163,285

(22) Filed: Jan. 24, 2014

(30) Foreign Application Priority Data
Jan. 24, 2013 (KR) 10-2013-0007921

(51) Int. Cl. H01Q 3/04

(52) U.S. Cl. CPC H01Q 3/04
USPC 343/766

(57) ABSTRACT

An apparatus and a method for controlling an antenna in a mobile communication system are provided. The apparatus includes constructing a Remote Electric Tilt (RET) antenna by a daisy chain separately from a daisy chain structure of a Radio frequency Unit (RU), a cable used for individually connecting the RU to the RET antenna can be reduced in length so as to reduce a consumption of materials, and the RET antenna can be installed without an installation of a power amplifier.

### CROSS-REFERENCE TO RELATED APPLICATION(S)

This application claims the benefit under 35 U.S.C. §119(a) of a Korean patent application filed on Jan. 24, 2013 in the Korean Intellectual Property Office and assigned Serial number 10-2013-0007921, the entire disclosure of which is hereby incorporated by reference.

### TECHNICAL FIELD

The present disclosure relates to a mobile communication system. More particularly, the present disclosure relates to an apparatus and a method for controlling an antenna.

### BACKGROUND

In a mobile communication system, a radiation pattern of an antenna in a base station may be affected by an external environment such as weather and may also be influenced by a change of a surrounding topology such as when a new base station is added or a new building is constructed. For reasons as described above, it is necessary to adjust a beam tilt of the antenna so as to provide a communication signal to a desired coverage. The beam tilt of the antenna has been manually adjusted by an operator. Since the antenna of the base station is generally mounted on a tower located at a hilly terrain like a mountain, there is a problem because the operator climbs the tower each time when an adjustment of the beam tilt is necessary, making the adjustment burdensome and expensive.

A scheme in which the beam tilt is electrically adjusted has been proposed. By using the electrically adjusted scheme, thereby not requiring the operator to climb the tower and adjust the antenna angle. However, although the beam tilt of the antenna is electrically adjusted, there are problems in that the operator must travel to the location that the antenna is located and time and cost are still required if it is considered that the antenna is located at a hilly terrain such as a mountain.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly an aspect of the present disclosure is to provide an apparatus and a method for constructing an independent daisy chain for a Remote Electric Tilt (RET) antenna that is separate from a daisy chain connection of a Radio frequency Unit (RU) in order to improve a conventional connection structure and an operating method in which one RU is directly connected to one RET antenna.

Another aspect of the present disclosure is to provide an apparatus and a method for installing a RET antenna, in which a cable used for individually connecting an RU to the RET antenna can be reduced in length so as to reduce a consumption of materials, and make a power amplifier unnecessary.

Another aspect of the present disclosure is to provide an apparatus and a method for differently changing an upper and lower angle of the antenna in each path when equipment of a base station is operated, in a configuration in which plural receiving paths (RX Path) may be set to one RU.

In accordance with an aspect of the present disclosure, a method of controlling an antenna unit of plural wireless units in a mobile communication system is provided. The method includes connecting a first antenna of N antenna units with a first wireless unit of the plural wireless units by a first cable, wherein the N antenna units are connected by a second cable.

In accordance with another aspect of the present disclosure, a method of controlling one of N antenna units in a mobile communication system is provided. The method includes connecting a first antenna of N antenna units with a first wireless unit of the plural wireless units by a first cable, wherein the N antenna units are connected by a second cable.

In accordance with another aspect of the present disclosure, an apparatus for controlling an antenna unit of a wireless unit in a mobile communication system is provided. The apparatus includes a controller for connecting a first antenna unit of N antenna units with a first wireless unit of the plural wireless units by a first cable, wherein the N antenna units are connected by a second cable.

In accordance with another aspect of the present disclosure, an apparatus for controlling an antenna unit of plural wireless units in a mobile communication system is provided. The apparatus includes a controller for connecting a first antenna unit of N antenna units with a first wireless unit of the plural wireless units by a first cable, wherein the N antenna units are connected by a second cable.

According to the present disclosure, a cable used for individually connecting an RU to the RET antenna can be reduced in length so as to reduce a consumption of materials and the RET antenna can be installed without an installation of a power amplifier.

According to the present disclosure, an upper and lower angle of the antenna in each path is changed when equipment of a base station is operated, in a configuration in which plural receiving paths (RX Path) may be set to one RU.

According to the present disclosure, when two pairs of two-receiving path type RET antennas are connected by the daisy chain, they can be used similar to a four-receiving path type RET antenna.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a view illustrating a configuration of a general Remote Electric Tilt (RET) system according to an embodiment of the present disclosure;

FIG. 2 is a view illustrating a configuration of an RET system according to an embodiment of the present disclosure;

FIG. 3 is a view illustrating a configuration of an RET system according to another embodiment of the present disclosure;

FIG. 4 is a flowchart illustrating a process of controlling an antenna according to the embodiment of the present disclosure; and

FIG. 5 is a block diagram illustrating an apparatus for controlling an antenna according to the embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes specific details to assist in that understanding but these are to be regarded as are merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

A scheme of controlling a beam tilt of the antenna from a remote place has been proposed in order to solve a problem in that an operator moves to a place at which the antenna is mounted although the beam tilt of the antenna is electrically adjusted. The scheme of controlling the beam tilt of the antenna is referred to as a Remote Electric Tilt (RET) scheme.

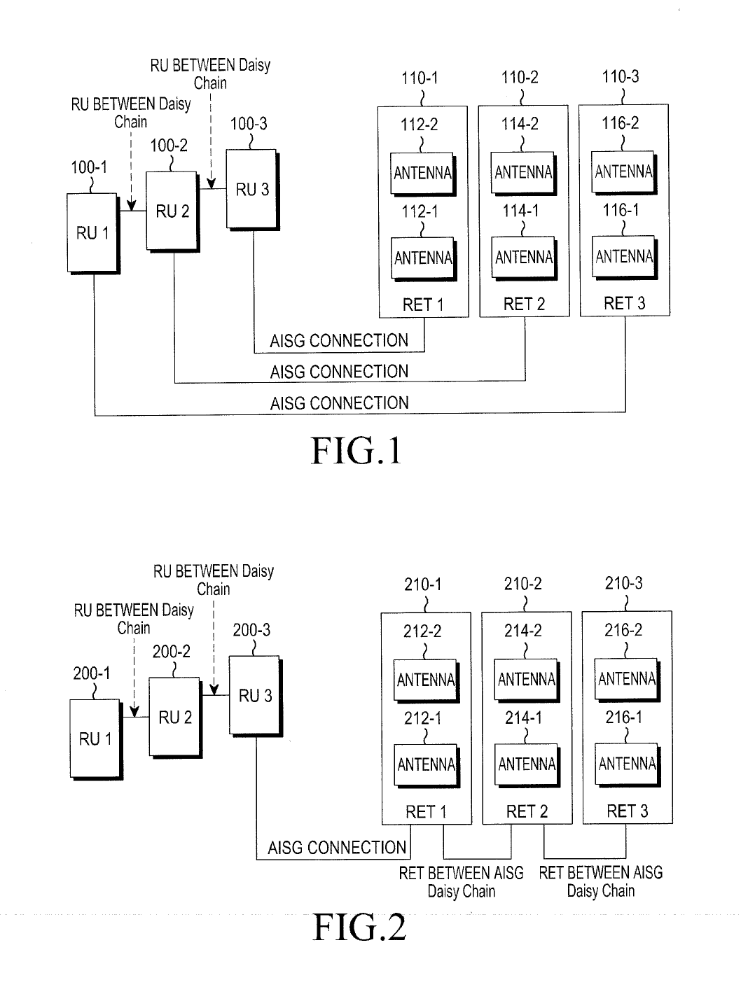

FIG. 1 is a view illustrating a configuration of a general RET system according to an embodiment of the present disclosure.

Referring to FIG. 1, RET units 110-1, 110-2, and 110-3 of control the beam tilt of the antenna from the remote location and include integral antenna equipment in which an antenna of a base station, an actuator, and a driving motor are configured as a set. Referring to FIG. 1, a Radio Frequency (RF) signal cable is omitted between the Radio frequency Unit (RU) and the RET unit.

The RET units 110-1, 110-2 and 110-3 are connected to a respective RU, which includes a transceiver and an amplifier of the base station. In the case that N RUs are installed at each sector, the RUs are connected by a daisy chain, and the RET units are connected to a respective RU.

At this time, when the RUs 100-1, 110-2 and 110-3 are connected to the RET units 110-1, 110-2 and 110-3 with a cable (not shown in FIG. 1) for the RF signal and a cable according to a standard of American Insurance Service Group (AISG), which is a standard for a control of the RET unit. Since the cable of the AISG standard supplies electric power to drive an electric motor of the RET unit, a loss of electric power occurs if the cable of the AISG standard is longer than a predetermined length. Accordingly, if the AISG cable is longer than the predetermined length, an amplifier is installed at an intermediate portion of the cable in order to prevent the loss of the electric power.

Further, in the case that the RU and the RET unit are not adjacent within a short-range, the RET units are adjacent in a first location while the RUs are adjacent in a second location. In this case, the number of AISG cables having a long length is equal to the number of the RET antennas, and thus there is significant difficulty in installing and maintaining the cables.

Furthermore, in the configuration in which one RU supports several receiving paths, the RET unit cannot be applied if antenna angles are different for each receiving path. In this case, there is a problem in that an antenna of which the angle is manually adjustable is installed.

The present disclosure proposes a method of connecting and operating the RET antenna equipment of the base station by a daisy chain. The daisy chain refers to a configuration of hardware devices which are continuously connected.

FIG. 2 is a view illustrating a configuration of an RET system according to an embodiment of the present disclosure.

Referring to FIG. 2, a first RU 200-1, a second RU 200-2 and a third RU 200-3 are connected by the daisy chain. Referring to FIG. 2, an RF signal cable is omitted between the RUs and the RET unit.

The third RU 200-3 is connected to a first RET unit 210-1 by the AISG cable. The first RET unit 210-1, a second RET unit 210-2 and a third RET unit 210-3 are connected by the AISG daisy chain. In the embodiment of the present disclosure, the first RET unit 210-1, the second RET unit 210-2 and the third RET unit 210-3 may include two or four antennas, respectively.

In the present disclosure, each of the N RUs are not directly connected to the N RET units, respectively. As shown in FIG. 2, at least one RET unit is connected to one RU and the RET units are connected by the daisy chain, thereby reducing use of the AISG cable and consumption of the materials.

A structure in which the first RET unit 210-1, the second RET unit 210-2 and the third RET unit 210-3 are connected by the AISG daisy chain is provided by using the AISG cable for the electric power and the control signal. An output terminal of the first RET unit 210-1 and an input terminal of the second RET unit 210-2 located next to the first RET unit 210-1 are configured to be physically connected.

By constructing the RET system as shown in FIG. 2, a cable used for individually connecting the RU to the RET unit can be reduced in length so as to reduce a consumption of materials and the RET unit can be installed without an installation of a power amplifier.

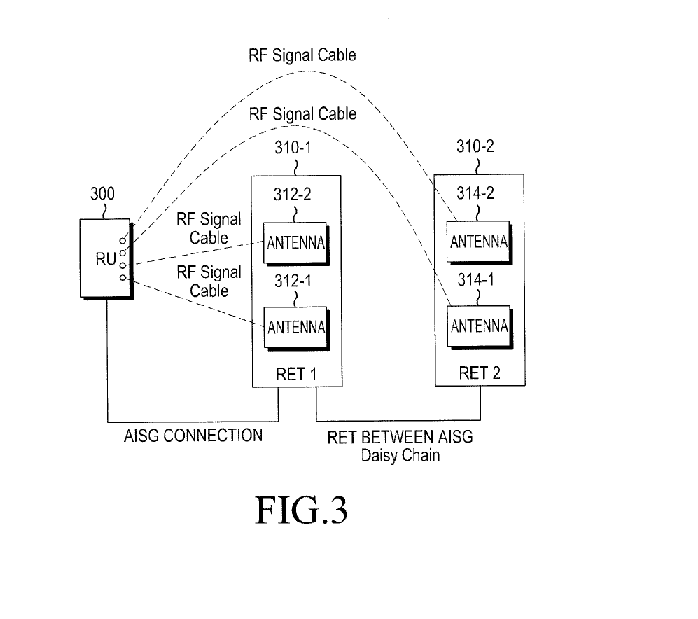

FIG. 3 is a view illustrating a configuration of an RET system according to another embodiment of the present disclosure.

Referring to FIG. 3, a method of connecting and operating the daisy chain of the RET unit in the case that RU 300 has several receiving paths will be described.

Referring to FIG. 3, a RF signal cable is omitted between the RU and the RET unit.

In the case that one RU has several receiving paths (i.e., the number of the RF signal cables and the number of the receiving paths are identical), the RU may be operated by changing an angle of an antenna for each path. At this time, in the case that one RU is connected to only one RET unit, the angle of the antenna for each path may be identically adjusted once. This is because only one RET unit includes each electric motor.

However, when the RET units are operated and connected by the daisy chain, the angle of the antenna can be adjusted differently for each path.

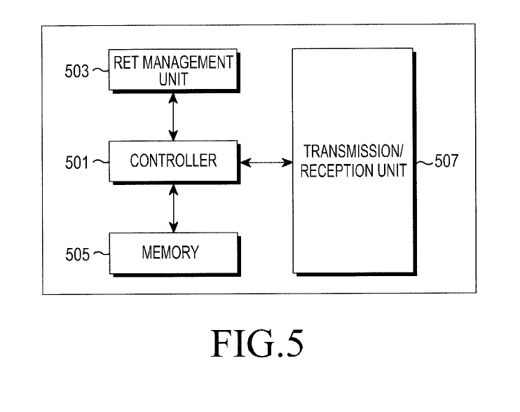

Referring to FIG. 5, as will be described later, a RET management unit 503 generates and manages a list of at least one RET unit indicative of when the RET units 310-1 and 310-2 are connected by the daisy chain. At this time, the RET management unit 503 manages an angle of the antenna, a calibration, a phase information and the like for each receiving path of each RET in the list.

Electric power for driving the electric motor of the RET unit is supplied from the RU. When two or more RET units are connected to one RU and simultaneously drive an electric motor, the electric power of the RU becomes weak and reduces RF electric power transmission, which is a basic function of the RU. Therefore, the present disclosure generally controls each of the two RET units independently by using software. Referring to FIGS. 3 and 5, when the RET management unit 503 generates a list of at least one RET unit connected to other RET units 310-1 and 310-2 by daisy chain, the controller controls the RET management unit so that the two RETs do not operate simultaneously.

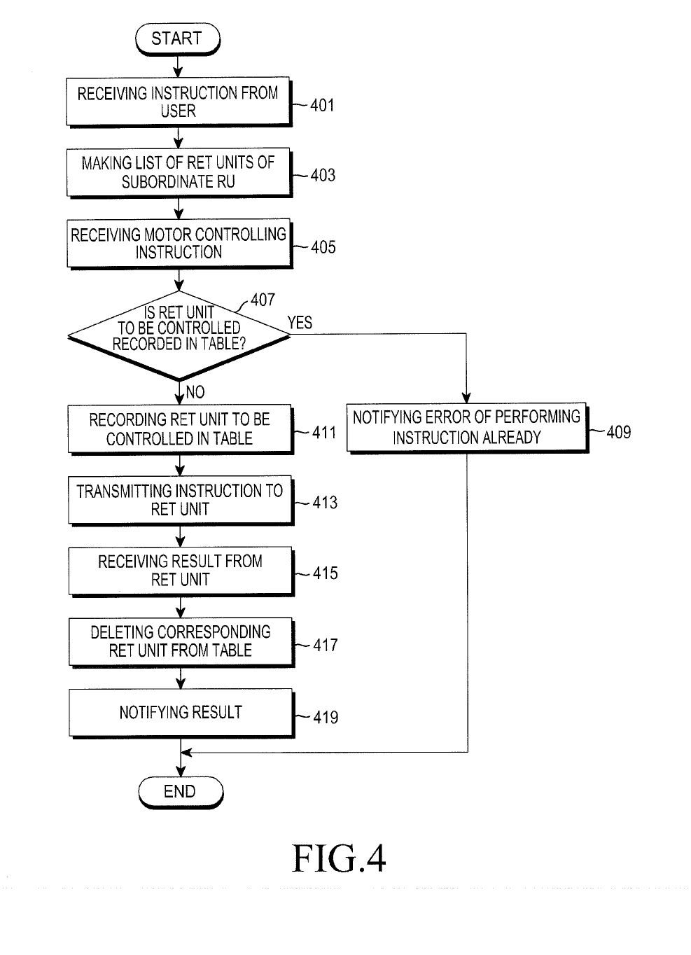

FIG. 4 is a flowchart illustrating a process of controlling an antenna according to the embodiment of the present disclosure.

Referring to FIG. 4, an antenna control device receives an instruction from a user in operation 401. Then, the antenna control device generates a list of the RET units of the RU (or subordinate RU) in a table in operation 403. When the list is generated, for example, the list includes relevant information such as an antenna angle, a calibration, and phase information of each receiving path of each RET unit. Additionally, when the list is generated, two RET units are controlled to not operate simultaneously. The generated list may be stored in a memory. Additionally, the antenna control device generates a control table that indicates whether the electric motor of the RET unit is controlled in operation 403.

When the antenna control device receives an instruction to control the electric motor, e.g., at least one of angle controlling, a calibration controlling, and a phase controlling, in operation 405, the antenna control device determines whether the RET unit to be controlled is recorded in the table.

If the RET unit to be controlled is the RET unit recorded in the control table, the antenna control device responds with an error message indicating that the RET unit of the subordinate RU is already performing the instruction in operation 409.

If the RET unit to be controlled is not the RET unit recorded in the table, however, the antenna control device records the RET unit to be controlled in the table in operation 411, and transmits an instruction to at least one RET unit in operation 413. Then, the antenna control device receives a result from the at least one RET unit in operation 415 and deletes a corresponding RET unit from the table in operation 417. The antenna control device notifies of the result to the controlling device or module in operation 419.

A method of controlling the antenna, which is proposed in the present disclosure, is as follows.

(1) The AISG cable is connected to an AISG output terminal of a first RET unit, and the AISG output terminal of the first RET unit and an AISG input terminal of a second RET unit are physically connected by using the daisy chain. The AISG input terminal of the first RET unit is a terminal for receiving an AISG output from the RU. This connection is continuously performed for the N number of the RET units.

(2) The RET units corresponding to a necessary number of antennas are connected in a daisy chain manner. However, more than twelve RET units should not be not connected due to a loss of electric power, a delay and the like.

FIG. 5 is a block diagram illustrating an apparatus for controlling an antenna according to the embodiment of the present disclosure.

Referring to FIG. 5, the antenna control device includes a RET management unit 503, a controller 501, a transmission/reception unit 507, a memory 505 and the like, in order to control the antenna according to the embodiment of the present disclosure.

The RET management unit 503 makes and manages a plurality of RET lists so as to connect the RET units by daisy chain. The RET management unit 503 generates and manages a list of at least one RET unit, in which the RET units 310-1 and 310-2 are connected by the daisy chain. At this time, the RET management unit 503 manages an angle of the antenna, a calibration, a phase information and the like for each receiving path of each RET unit.

The transmission/reception unit 507 receives and transmits various instructions, signals and the like.

The memory 505 stores a list made by the RET management unit 503 as described above.

The controller 501 controls the RET management unit 503, the memory 505, the transmission/reception unit 507, and the like.

A method of controlling an antenna by the controller 501 of FIG. 5 according to the embodiment of the present disclosure will be described.

The controller 501, shown in FIG. 5, has to identify a set of RET units connected to one RU.

If the RET unit performs an instruction for driving a motor, e.g., angle adjustment, calibration adjustment, phase adjustment and the like, the controller 501 identifies whether one of the RET units sharing the RU with the corresponding RET unit is currently operating the electric motor.

The controller 501 prevents a new instruction from be executed while one RET unit sharing the RU performs an operation of driving its respective electric motor.

According to the present disclosure, a cable used for individually connecting an RU to the RET unit can be reduced in length so as to reduce a consumption of materials and the RET unit can be installed without an installation of a power amplifier.

According to the present disclosure, an upper and lower angle of the antenna in each path is changed when equipment of a base station is operated, in a configuration in which plural receiving paths may be set to one RU.

According to the present disclosure, when two pairs of two-receiving path type RET antennas are connected in the daisy chain configuration, the RET antennas can be used like a four-receiving path type RET antenna. Since some manufacturers produce four-receiving path type RET antennas, an antenna of which an angle is manually adjusted must be used in an area at which the four-receiving path type RET antenna is installed.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of controlling an antenna unit of plural wireless units in a mobile communication system, the method comprising:
connecting a first antenna unit of N antenna units with a first wireless unit of the plural wireless units by a first cable,
wherein the N antenna units are connected by a second cable.

2. The method of claim 1, wherein the first cable is an American Insurance Service Group (AISG) cable.

3. The method of claim 1, wherein the second cable is a daisy chain using an American Insurance Service Group (AISG) input/output terminal.

4. The method of claim 1, further comprising:
making a list of the N antenna units;
determining whether an antenna unit to be controlled is an antenna unit recorded in the list when an instruction for controlling an electric motor is received;
recording the antenna unit to be controlled if the antenna to be controlled is not the recorded antenna unit; and
transmitting the motor control instruction to the antenna to be controlled.

5. The method of claim 4, further comprising:
controlling two antenna units to operate at different times.

6. The method of claim 4, further comprising:
making the list including at least one of an antenna angle, a calibration, and phase information for each receiving path of each antenna unit.

7. A method of controlling one of N antenna units in a mobile communication system, the method comprising:
connecting a first antenna unit of N antenna units with a first wireless unit of the plural wireless units by a first cable,
wherein the N antenna units are connected by a second cable.

8. The method of claim 7, wherein the first cable is an American Insurance Service Group (AISG) cable.

9. The method of claim 7, wherein the second cable is a daisy chain using an American Insurance Service Group (AISG) input/output terminal.

10. An apparatus for controlling an antenna unit of a wireless unit in a mobile communication system, the apparatus comprising:
a controller for connecting a first antenna unit of N antenna units with a first wireless unit of the plural wireless units by a first cable,
wherein the N antenna units are connected by a second cable.

11. The apparatus of claim 10, wherein the first cable is an American Insurance Service Group (AISG) cable.

12. The apparatus of claim 10, wherein the second cable is a daisy chain using an American Insurance Service Group (AISG) input/output terminal.

13. The apparatus of claim 10, wherein the controller makes a list of the N antenna units, determines whether an antenna unit to be controlled is an antenna recorded in the list when receiving a motor controlling instruction, records the antenna unit to be controlled if the antenna unit to be controlled is not the recorded antenna unit, and transmits the motor control instruction to the antenna unit to be controlled.

14. The apparatus of claim 13, wherein the controller controls two antenna units to operate at different times.

15. The apparatus of claim 13, wherein the controller makes the list including at least one of an antenna angle, a calibration, phase information for each receiving path of each antenna unit.

16. An apparatus for controlling an antenna unit of plural wireless units in a mobile communication system, the apparatus comprising:
a controller for connecting a first antenna unit of N antenna units with a first wireless unit of the plural wireless units by a first cable,
wherein the N antenna units are connected by a second cable.

17. The apparatus of claim 16, wherein the first cable is an American Insurance Service Group (AISG) cable.

18. The apparatus of claim 16, wherein the second cable is a daisy chain using an American Insurance Service Group (AISG) input/output terminal.

19. The apparatus of claim 16, wherein a second wireless unit is connected to the first wireless unit and configured to control a second antenna unit of the N antenna units.

20. The apparatus of claim 16, wherein a third wireless unit is connected to the second wireless unit and configured to control a third antenna unit of the N antenna units.
